(19) United States
(12) Patent Application Publication
(10) Pub. No.: US 2025/0232216 A1
(43) Pub. Date: Jul. 17, 2025

(54) ITERATIVE LEARNING WITH ADAPTED TRANSMISSION AND RECEPTION

(71) Applicant: Telefonaktiebolaget LM Ericsson (publ), Stockholm (SE)

(72) Inventors: Henrik RYDÉN, Stockholm (SE); Reza MOOSAVI, Linköping (SE); Erik G. LARSSON, Linköping (SE)

(21) Appl. No.: 18/877,019

(22) PCT Filed: Jul. 25, 2022
(86) PCT No.: PCT/SE2022/050726

§ 371 Date: Dec. 19, 2024

(51) Int. Cl. G06N 20/00

(52) U.S. Cl. CPC G06N 20/00

(57) ABSTRACT

There is provided techniques for an iterative learning process being performed between a server entity and agent entities. The iterative learning process pertains to a computational task to be performed by the agent entities. The computational task pertains to the agent entities participating in training a machine learning model. For each iteration round of the iterative learning process the server entity sends a global parameter vector of the computational task to the agent entities. For each iteration round of the iterative learning process a local model parameter vector with locally computed computational results is sent per agent entity to the server entity. The locally computed computational results are updates of the machine learning model.

### TECHNICAL FIELD

Embodiments presented herein relate to a method, a server entity, a computer program, and a computer program product for performing an iterative learning process with agent entities. Embodiments presented herein further relate to a method, an agent, a computer program, and a computer program product for performing an iterative learning process with the server entity.

### BACKGROUND

The increasing concerns for data privacy have motivated the consideration of collaborative machine learning (ML) systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node.

In general terms, FL might be regarded as an ML technique that trains an ML (or artificial intelligence; AI) model across multiple decentralized agents, each performing local model training using local data samples. The technique requires multiple interactions of the model, but no exchange of local data samples. In this respect, an ML, or AI, model might be regarded as a data driven algorithm that applies AI/ML techniques to generate a set of outputs based on a set of inputs. Therefore, AI/ML model training might be regarded as a process to train an AI/ML model by learning the input/output relationship in a data driven manner and obtain the trained AI/ML model for inference. An AI/ML model might be delivered over the air interface; either parameters of a model structure known at the receiving end or a new model with parameters. In this respect, a model download refers to model transfer from the PS to the agents, and model upload refers to model transfer from the agents to the PS.

In further details, FL is an iterative process where each global iteration, often referred to as iteration round, is divided into three phases: In a first phase the PS sends the current model parameter vector to all participating agents. In a second phase each of the agents performs one or several steps of a stochastic gradient descent (SGD) procedure on its own training data based on the current model parameter vector and obtains a model update. In a third phase the model updates from all agents are sent to the PS, which aggregates the received model updates and updates the parameter vector for the next iteration based on the model updates according to some aggregation rule. The first phase is then entered again but with the updated parameter vector as the current model parameter vector.

Transmission of the model updates from the agents to the PS in the uplink is comparatively resource-consuming. Approaches have therefore been devised to reduce the resources required for transmission of the model updates from the agents to the PS in the uplink. Some, existing approaches involve sparsification of the model updates before transmission, quantization of the model updates before transmission, and transmitting only the sign of model updates. All these approaches entail a loss of information, and with that a loss of model convergence performance. There are also other approaches, such as federated learning with over-the-air computation that uses the superposition nature of the wireless medium to compute the federation averaging over-the-air. However, such approaches require synchronization between all agents and are prone to jamming and interference unless actions to mitigate these issues are taken.

Further, the broadcasting of the model parameter vector is also comparatively resource-consuming. This in turn incurs costs in terms of delays for other types of traffic, and energy consumption in the network node from which the model parameter vector is broadcast (because of the transmission) and in the user equipment (since the user equipment must receive and decode the information).

Hence, there is a need for further improved communication between the PS and the agents.

### SUMMARY

An object of embodiments herein is to address the above issues in order to enable efficient communication between the PS (hereinafter denoted server entity) and the agents (hereinafter denoted agent entities), especially for transmitting the model updates of an iterative learning process from the agents towards the PS.

According to a first aspect there is presented a method for performing an iterative learning process with agent entities. The method is performed by a server entity. The iterative learning process pertains to a computational task to be performed by the agent entities. The computational task pertains to the agent entities participating in training a machine learning model. For each iteration round of the iterative learning process the server entity sends a global parameter vector of the computational task to the agent entities. For each iteration round of the iterative learning process a local model parameter vector with locally computed computational results is sent per agent entity to the server entity. The locally computed computational results are updates of the machine learning model. The method comprises transmitting the global parameter vector of a current iteration round of the iterative learning process to the agent entities. The method comprises receiving a respective local model parameter vector of the current iteration round of the iterative learning process from the agent entities. The method comprises obtaining information of an importance score given per each component of the global parameter vector and/or of the local model parameter vector. The method comprises adapting transmission per each component of the global parameter vector for a next iteration round of the iterative learning process based on the importance score per parameter when the importance score is given per parameter of the global parameter vector, and/or adapting reception per each component of the local model parameter vector for the next iteration round of the iterative learning process based on the importance score per parameter when the importance score is given per parameter of the local model parameter vector.

According to a second aspect there is presented a server entity for performing an iterative learning process with agent entities. The iterative learning process pertains to a computational task to be performed by the agent entities. The computational task pertains to the agent entities participating in training a machine learning model. For each iteration round of the iterative learning process the server entity sends a global parameter vector of the computational task to the agent entities. For each iteration round of the iterative learning process a local model parameter vector with locally computed computational results is sent per agent entity to the server entity. The locally computed computational results are updates of the machine learning model. The server entity comprises processing circuitry. The processing circuitry is configured to cause the server entity to transmit the global parameter vector of a current iteration round of the iterative learning process to the agent entities. The processing circuitry is configured to cause the server entity to receive a respective local model parameter vector of the current iteration round of the iterative learning process from the agent entities. The processing circuitry is configured to cause the server entity to obtain information of an importance score given per each component of the global parameter vector and/or of the local model parameter vector. The processing circuitry is configured to cause the server entity to adapt transmission per each component of the global parameter vector for a next iteration round of the iterative learning process based on the importance score per parameter when the importance score is given per parameter of the global parameter vector, and/or adapt reception per each component of the local model parameter vector for the next iteration round of the iterative learning process based on the importance score per parameter when the importance score is given per parameter of the local model parameter vector.

According to a third aspect there is presented a server entity for performing an iterative learning process with agent entities. The iterative learning process pertains to a computational task to be performed by the agent entities. The computational task pertains to the agent entities participating in training a machine learning model. For each iteration round of the iterative learning process the server entity sends a global parameter vector of the computational task to the agent entities. For each iteration round of the iterative learning process a local model parameter vector with locally computed computational results is sent per agent entity to the server entity. The locally computed computational results are updates of the machine learning model. The server entity comprises a transmit module configured to transmit the global parameter vector of a current iteration round of the iterative learning process to the agent entities. The server entity comprises a receive module configured to receive a respective local model parameter vector of the current iteration round of the iterative learning process from the agent entities. The server entity comprises an obtain module configured to obtain information of an importance score given per each component of the global parameter vector and/or of the local model parameter vector. The server entity comprises an adapt module configured to adapt transmission per each component of the global parameter vector for a next iteration round of the iterative learning process based on the importance score per parameter when the importance score is given per parameter of the global parameter vector, and/or adapt reception per each component of the local model parameter vector for the next iteration round of the iterative learning process based on the importance score per parameter when the importance score is given per parameter of the local model parameter vector.

According to a fourth aspect there is presented a computer program for performing an iterative learning process with agent entities, the computer program comprising computer program code which, when run on processing circuitry of a server entity, causes the server entity to perform a method according to the first aspect.

According to a fifth aspect there is presented a method for performing an iterative learning process with a server entity. The method is performed by an agent entity. The iterative learning process pertains to a computational task to be performed by the agent entity. The computational task pertains to the agent entity participating in training a machine learning model. For each iteration round of the iterative learning process the server entity sends a global parameter vector of the computational task to the agent entity. For each iteration round of the iterative learning process the agent entity sends a local model parameter vector with locally computed computational results to the server entity. The locally computed computational results are updates of the machine learning model. The method comprises receiving the global parameter vector of a current iteration round of the iterative learning process from the server entity. The method comprises transmitting a local model parameter vector of the current iteration round of the iterative learning process to the agent entity. The method comprises obtaining information of an importance score given per each component of the global parameter vector and/or of the local model parameter vector. The method comprises adapting reception per each component of the global parameter vector for the next iteration round of the iterative learning process based on the importance score per parameter when the importance score is given per parameter of the global parameter vector, and/or adapting transmission per each component of the local model parameter vector for a next iteration round of the iterative learning process based on the importance score per parameter when the importance score is given per parameter of the local model parameter vector.

According to a sixth aspect there is an agent entity for performing an iterative learning process with a server entity. The iterative learning process pertains to a computational task to be performed by the agent entity. The computational task pertains to the agent entity participating in training a machine learning model. For each iteration round of the iterative learning process the server entity sends a global parameter vector of the computational task to the agent entity. For each iteration round of the iterative learning process the agent entity sends a local model parameter vector with locally computed computational results to the server entity. The locally computed computational results are updates of the machine learning model. The agent entity comprises processing circuitry. The processing circuitry being configured to cause the agent entity to receive the global parameter vector of a current iteration round of the iterative learning process from the server entity. The processing circuitry being configured to cause the agent entity to transmit a local model parameter vector of the current iteration round of the iterative learning process to the agent entity. The processing circuitry being configured to cause the agent entity to obtain information of an importance score given per each component of the global parameter vector and/or of the local model parameter vector. The processing circuitry being configured to cause the agent entity to adapt reception per each component of the global parameter vector for the next iteration round of the iterative learning process based on the importance score per parameter when the importance score is given per parameter of the global parameter vector, and/or adapt transmission per each component of the local model parameter vector for a next iteration round of the iterative learning process based on the importance score per parameter when the importance score is given per parameter of the local model parameter vector.

According to a seventh aspect there is presented an agent entity for performing an iterative learning process with a server entity. The iterative learning process pertains to a computational task to be performed by the agent entity. The computational task pertains to the agent entity participating in training a machine learning model. For each iteration round of the iterative learning process the server entity sends a global parameter vector of the computational task to the agent entity. For each iteration round of the iterative learning process the agent entity sends a local model parameter vector with locally computed computational results to the server entity. The locally computed computational results are updates of the machine learning model. The agent entity comprises a receive module configured to receive the global parameter vector of a current iteration round of the iterative learning process from the server entity. The agent entity comprises a transmit module configured to transmit a local model parameter vector of the current iteration round of the iterative learning process to the agent entity. The agent entity comprises an obtain module configured to obtain information of an importance score given per each component of the global parameter vector and/or of the local model parameter vector. The agent entity comprises an adapt module configured to adapt reception per each component of the global parameter vector for the next iteration round of the iterative learning process based on the importance score per parameter when the importance score is given per parameter of the global parameter vector, and/or adapt transmission per each component of the local model parameter vector for a next iteration round of the iterative learning process based on the importance score per parameter when the importance score is given per parameter of the local model parameter vector.

According to an eighth aspect there is presented a computer program for performing an iterative learning process with a server entity, the computer program comprising computer program code which, when run on processing circuitry of an agent entity, causes the agent entity to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient utilization of available downlink and/or uplink radio resources.

Advantageously, these aspects improve the energy-efficiency of distributed (e.g. federated) machine learning systems that operate over wireless links.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3 and 5 are flowcharts of methods according to embodiments;

FIG. 4 is a schematic illustration of constellation points according to embodiments;

FIG. 6 is a schematic illustration of part of a communication network according to embodiments;

FIG. 7 is a signalling diagram according to an embodiment;

FIG. 8 is a schematic diagram showing functional units of a server entity according to an embodiment;

FIG. 9 is a schematic diagram showing functional modules of a server entity according to an embodiment;

FIG. 10 is a schematic diagram showing functional units of an agent entity according to an embodiment;

FIG. 11 is a schematic diagram showing functional modules of an agent entity according to an embodiment;

FIG. 12 shows one example of a computer program product comprising computer readable means according to an embodiment;

FIG. 13 is a schematic diagram illustrating a telecommunication network connected via an intermediate network to a host computer in accordance with some embodiments; and

FIG. 14 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device

Further, the wording that a certain data item, piece of information, etc. is sent from a first device to a second device should be construed as that data item or piece of information being sent either directly from the first device to the second device or from the first device to the second device via at least one intermediate device.

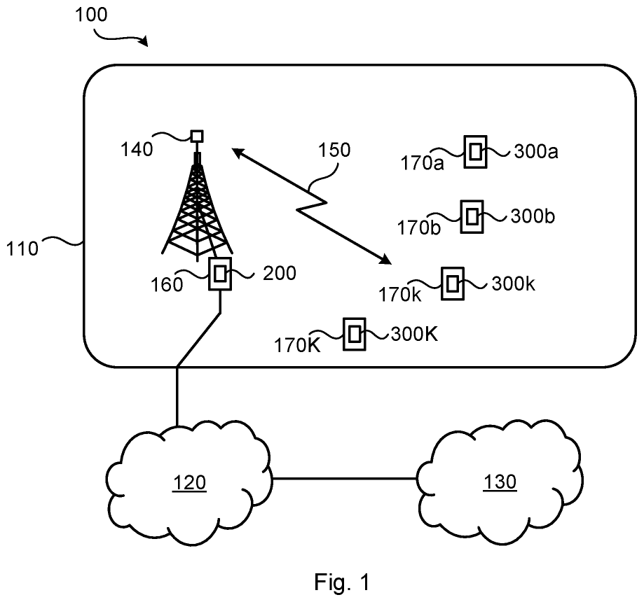

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a:170K is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a:170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a:170K are to be utilized during an iterative learning process and that the user equipment 170a:170K as part of performing the iterative learning process are to report computational results to the network node 160. The network node 160 therefore comprises, is collocated with, or integrated with, a server entity 200. Hence, the server entity 200 might be part of, collocated with, or integrated with, the network node 160. Each of the user equipment 170a:170K comprises, is collocated with, or integrated with, a respective agent entity 300a:300K. Hence, each agent entity 300a:300K might be part of, collocated with, or integrated with, a respective user equipment 170a:170K. In some aspects, the server entity 200 and the agent entities 300a:300K are provided in a distributed computing architecture.

Consider a system with a server entity 200 and K agent entities 300a:300K. The server entity 200 and the agent entities 300a:300K communicate over a shared medium for which broadcasting is possible, i.e., transmission of information that can be received simultaneously by several agent entities 300a:300K. A prime example of such a medium is the wireless channel, where techniques such as Long Term Evolution (LTE) and New Radio (NR) and as standardized by the third generation partnership project (3GPP). Henceforth a wireless communication medium is assumed.

A learning model is iteratively trained. The procedure for one iteration round will be summarized next. First, the server entity 200 broadcasts a parameter vector (which could be differentially to a previously broadcasted model, as detailed below). This parameter vector is assumed to be received by the agent entities 300a:300K. Each of the agent entities 300a:300K then computes a local model update based on local training data, and then sends their locally obtained updates to the server entity 200. Finally, the server entity 200 aggregates all received local updates to update the learning model.

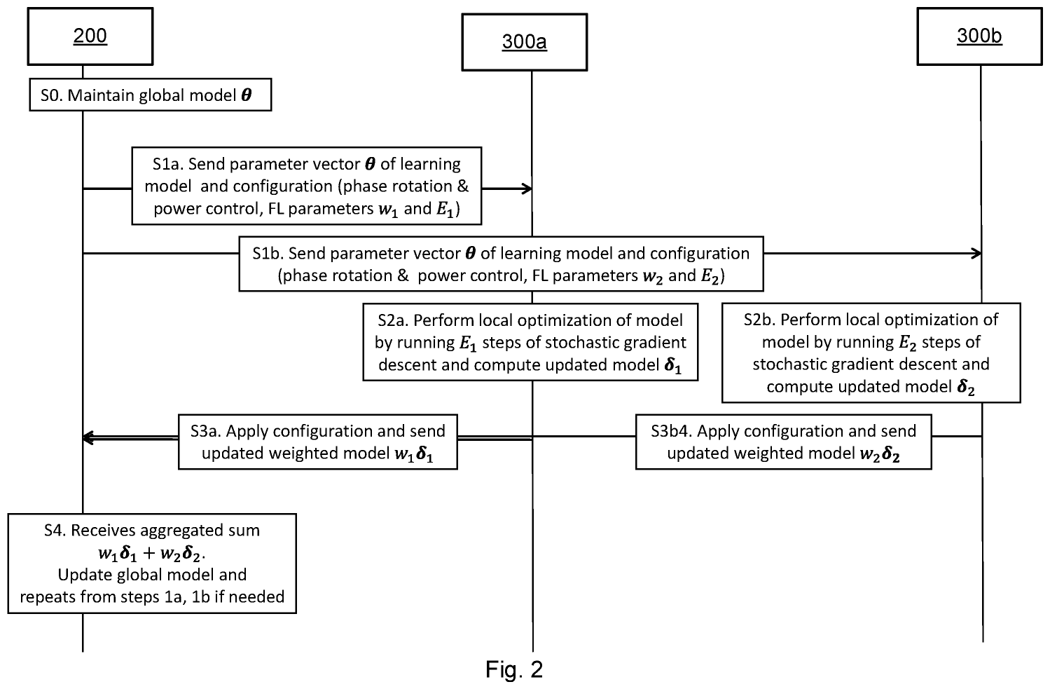

Reference is next made to the signalling diagram of FIG. 2, illustrating an example of a nominal iterative learning process. Consider a setup with K agent entities 300a:300K, and one server entity 200. Each transmission from the agent entities 300a:300K is allocated N resource elements (REs). These can be time/frequency samples, or spatial modes. For simplicity, but without loss of generality, the example in FIG. 2 is shown for two agent entities 300a, 300b, but the principles hold also for larger number of agent entities 300a:300K.

The server entity 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server entity 200 sends the current parameter vector of the learning model, θ(i), to the agent entities 300a, 300b.

In this respect, there could be different ways in which the current parameter vector of the learning model, θ(i), is sent to the agent entities 300a, 300b, such as unicast digital transmission, broadcast transmission, or multicast transmission. Some properties of each of these types of transmissions will be disclosed next.

With unicast digital transmission, the server entity 200 allocates orthogonal time, frequency, and/or spatial, resources to each agent entity 300a, 300b. For each agent entity 300a, 300b, a corresponding transmission rate as well as coding and modulation scheme are determined. The model, or a differential update compared to the previously broadcasted model, is quantized and compressed using a source code. For each agent entity 300a, 300b, a modulation and coding scheme is applied, tailored to the rate that the channel to this agent entity 300a, 300b can support. Each agent entity 300a, 300b then decodes the transmission that contains the model (or its differential update).

With broadcast transmission, the server entity 200 transmits in such a way that all agent entities 300a, 300b can decode the model. Since the properties of the radio propagation channel 150 differ for each of the agent entities 300a, 300b, for example resulting in the pathloss being different for the different agent entities 300a, 300b, this can require that the transmission rate is selected very low (using heavy error control coding). An alternative is to use an error control code that can be decoded using only partially received bits. For example, if one uses a channel code (e.g., low density parity check codes; LDPC) with a pseudo-random structure of its parity check matrix, then the agent entities 300a, 300b with small pathloss (and therefore a high received sign al to noise ratio; SNR) may decode the model broadcast after receiving a relatively small number of bits. In contrast, agent entities 300a, 300b with a higher pathloss will have to receive more parity bits before decoding is possible. Agent entities experiencing a comparatively high SNR (compared to other agent entities) could not only decode the model faster but also start their training computation (e.g., stochastic gradient) earlier, hence enabling a reduction in clock frequency of the computation which in turn results in lower power consumption.

With multicast transmission, the agent entities 300a, 300b can be partitioned in different groups, where one respective uplink pilot resource is assigned per each group. In this way, when beamformed transmission is used, multiple beams can be used, where each beam is adapted to serve a particular group of agent entities 300a, 300b. Multicast transmission might be regarded as a combination of unicast and broadcast techniques and there may be circumstances where such grouping is preferable for performance reasons.

Steps S2a, S2b: Each agent entity 300a, 300b performs a local optimization of the model by running T steps of a stochastic gradient descent update on θ(i), based on its local training data;

$${θ}_{k} ( i , τ ) = {θ}_{k} ( i , τ - 1 ) - {η}_{k} ∇ {f}_{k} ( {θ}_{k} ( i , τ - 1 ) ) , τ = 1 , … , T ,$$

where ηₖ is a weight and fₖ is the objective function used at agent entity k (and which is based on its locally available training data).

Steps S3a, S3b: Each agent entity 300a, 300b transmits to the server entity 200 their model update δₖ(i);

$${δ}_{k} ( i ) = {θ}_{k} ( i , T ) - {{θ}_{k} ( i , 0 )}_{j} ,$$

where θₖ(i, 0) is the model that agent entity k received from the server entity 200. Steps S3a, S3b may be performed sequentially, in any order, or simultaneously.

Step S4: The server entity 200 updates its estimate of the parameter vector θ(i) by adding to it a linear combination (weighted sum) of the updates received from the agent entities 300a, 300b;

$$θ ( i + 1 ) = θ ( i ) + {w}_{1} {δ}_{1} ( i ) + {w}_{2} {δ}_{2} ( i )$$

where wₖ are weights.

Assume now that there are K agent entities and hence K model updates. When the model updates {δ₁, . . . , δ_{K}} (where the time index has been dropped for simplicity) from the agent entities 300a:300K over a wireless communication channel, there are specific benefits of using direct analog modulation. For analog modulation, the k:th agent entity could transmit the N components of δₖ directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δ_{K}. More specifically, rather than sending δ₁, . . . , δ_{K} to the server entity 200 on separate channels, the agent entities 300a:300K could send the model updates {δ₁, . . . , δ_{K}} simultaneously, using N REs, through linear analog modulation. The server entity 200 could then exploit the wave superposition property of the wireless communication channel, namely that {δ₁, . . . , δ_{K}} add up “in the air”. Neglecting noise and interference, the server entity 200 would thus receive the linear sum, δ₁+δ₂+ . . . +δ_{K}, as desired. That is, the server entity 200 ultimately is interested only in the aggregated model update δ₁+δ₂+ . . . +δ_{K}, but not in each individual parameter vector {δ₁, . . . , δ_{K}}. This technique can thus be referred to as iterative learning with over-the-air computation.

The over-the-air computation assumes that appropriate power control is applied (such that all transmissions of {δₖ} are received at the server entity 200 with the same power), and that each transmitted δₖ is appropriately phase-rotated prior to transmission to pre-compensate for the phase rotation incurred by the channel from agent entity k to the server entity 200.

One benefit of the thus described over-the-air computation is the savings of radio resources. With two agent entities (K=2), 50% resources are saved compared to standard FL since the two agent entities can send their model updates simultaneously in the same RE. With K agent entities, only a fraction 1/K of the nominally required resources are needed.

As disclosed above, there is a need for further improved communication between the PS and the agents.

Taking a machine learning problem involving training a neural network as an example, the selection of the neural network configuration (e.g. hidden layers, number of neurons, etc.) in combination with the input data structure can create many close-to-zero model weights. Typically, close-to-zero weights have low impact on the model output. However, the server entity 200 typically is not aware how such close-to-zero elements affects the model performance. It can be challenging to find what parameters that can be set to zero (to reduce signaling overhead) without comprising model prediction performance.

At least some of the herein disclosed embodiments are therefore based on that the server entity 200 and/or the agent entities 300a:300K determines which components of the global parameter vector (as sent by the server entity 200) and/or of the local model parameter vectors (as sent by the agent entities 300a:300K) that are most important. This information is defined by a component-wise importance score. Transmission per each component of the global parameter vector and/or the model parameter vectors can in that way be updated based on the importance score given per each component of the global parameter vector and/or of the local model parameter vector.

The embodiments disclosed herein in particular relate to techniques for a server entity 200 to perform an iterative learning process with agent entities 300a:300K and for an agent entity 300k to perform an iterative learning process with the server entity 200. In order to obtain such techniques there is provided a server entity 200, a method performed by the server entity 200, a computer program product comprising code, for example in the form of a computer program, that when run on processing circuitry of the server entity 200, causes the server entity 200 to perform the method. In order to obtain such techniques there is further provided an agent entity 300k, a method performed by the agent entity 300k, and a computer program product comprising code, for example in the form of a computer program, that when run on processing circuitry of the agent entity 300k, causes the agent entity 300k to perform the method.

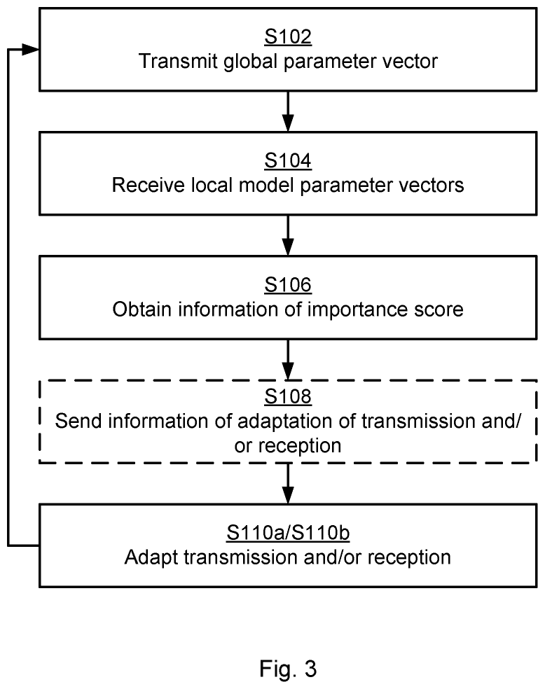

Reference is now made to FIG. 3 illustrating a method for performing an iterative learning process with agent entities 300a:300K as performed by the server entity 200 according to an embodiment.

The iterative learning process pertains to a computational task to be performed by the agent entities 300a:300K. The computational task pertains to the agent entities 300a:300K participating in training a machine learning model. For each iteration round of the iterative learning process the server entity 200 sends a global parameter vector of the computational task to the agent entities 300a:300K. For each iteration round of the iterative learning process a local model parameter vector with locally computed computational results is sent per agent entity 300a:300K to the server entity 200. The locally computed computational results are updates of the machine learning model.

S102: The server entity 200 transmits the global parameter vector of a current iteration round of the iterative learning process to the agent entities 300a:300K.

S104: The server entity 200 receives a respective local model parameter vector of the current iteration round of the iterative learning process from the agent entities 300a:300K.

S106: The server entity 200 obtains information of an importance score given per each component of the global parameter vector and/or of the local model parameter vector.

Then, at least one of steps S110a and S110b is performed. That is, either step S110a is performed but step S110b is not performed, or step S110b is performed but step S110a is not performed, or boths step S110a and S110b are performed.

S110a: The server entity 200 adapts transmission per each component of the global parameter vector for a next iteration round of the iterative learning process based on the importance score per parameter when the importance score is given per parameter of the global parameter vector.

S110b: The server entity 200 adapts reception per each component of the local model parameter vector for the next iteration round of the iterative learning process based on the importance score per parameter when the importance score is given per parameter of the local model parameter vector.

Embodiments relating to further details of performing an iterative learning process with agent entities 300a:300K as performed by the server entity 200 will now be disclosed.

Aspects of the importance score will be disclosed next.

For a learning problem with a model parameter vector of length N, the importance score in general can be defined as a vector of length N where each component represents the importance score of the corresponding parameter in the machine learning problem. In that regard, a higher value denotes that the parameter has more importance in the machine learning problem, and hence is more important to convey from the transmitter to the receiver as part of the the iterative learning process.

There could be different types of importance scores. In some examples, the importance score per given component pertains to a priority score for the given component for contributing to the training of the machine learning model.

In general terms, the importance score given per each component of the global parameter vector and/or of the local model parameter vector might be determined either at the server entity side, at the agent entity side, or jointly at the server entity side and at the agent entity side.

In case the importance score is determined either at the server entity side or jointly at the server entity side and at the agent entity side, the server entity 200 might explicitly inform the agent entities 300a:300K how the transmission and/or reception was adapted before the next iteration round so that the agent entities 300a:300K can adapt their own reception and/or transmission accordingly. Hence, in some embodiments, the server entity 200 is configured to perform (optional) step S108.

S108: The server entity 200 sends, before the next iteration round and to the agent entities 300a:300K, information of how the transmission and/or reception was adapted.

In general terms, the agent entities 300a:300K can assist the server entity 200 in computing the importance scores. This can be done for example by the agent entities 300a:300K sending a subset of their training data to help the server entity 200 to estimate the importance scores. This however requires signaling overhead in the uplink. Alternatively, the importance scores can be computed by the agent entities 300a:300K based on a configuration from the server entity 200 and then report the importance scores back to the server entity 200. This option requires less signaling overhead compared to the transmission of raw data. Moreover, it has the advantage that the importance scores are computed directly by the agent entities 300a:300K that have access to the local training data, which yields to more accurate importance estimation.

Aspects where the importance score is determined at the server entity side will be disclosed next.

The server entity 200 might determine the importance score for a certain component of the global parameter vector and/or of the local model parameter vector by measuring the output variation and associated accuracy, or loss impact, when performing perturbations of weights for the component. In some examples, the server entity 200 can, if not having access to any test data, use a set of random inputs to the global parameter vector and measure how the output is sensitive to a perturbation, for example if the output statistics is very different when applying a certain model parameter perturbation in comparison to no perturbation. In particular, in some embodiments, the server entity 200 obtains the information of the importance score by estimating accuracy per each component of the local model parameter vectors as received from the agent entities 300a:300K. Further, in some embodiments, each of the components has a respective magnitude, and the importance score for a given component is a function of the magnitude for the given component, and/or a function of the magnitude of the given component for a present iteration round compared to a reference, and the reference is the magnitude of the given component computed for a previous iteration round, and the importance score increases with the magnitude.

The importance score, when the server entity 200 does not have access to any training data, can, for example, be depend on how much each component varies from one iteration round to the next. If a given component varies more than a threshold value, then the given component is assigned a high importance score, and else the given component is assigned a low importance score.

The importance score, retrieved when the server entity 200 has access to some training data, can, for example, depend on how the accuracy or loss degrades with a certain model parameter perturbation. If a given component is degraded more than a threshold value, then the given component is assigned a high importance score, and else the given component is assigned a low importance score.

In some aspects, the importance score is based on the magnitude of the components of the global parameter vector and/or of the local model parameter vector.

In some aspects, the server entity 200 sets one importance score for each layer in the neural network. In particular, in some embodiments, the components represent weights at different layers in a neural network, and the weights have same importance score per each layer of the neural network. The per neural network-layer importance score will impact the adaptation in subsequent actions, for example the server entity 200 might determine to select a lower modulation and codings scheme for the neural network-layers with high importance score.

In some aspects, a more robust modulation and coding scheme is used for the components associated with a comparatively high importance score than components associated with a comparatively low importance score. In general terms, robustness is a function of code rate (for channel error protection) and number of constellation points (for modulation). Robustness increases as the code rate increases and as the number of constellation points decreases, and vice versa. Robustness also depends on the type of modulation used for a given number of constellation points.

Aspects where the importance score is determined jointly at the server entity side and at the agent entity side will be disclosed next.

To reduce the signaling overhead, in one example, the superposition nature of the wireless access medium is deployed to compute the importance score over-the-air. In this case, the agent entities 300a:300K first compute the importance scores of each component (or model parameter) in the local model parameter vector to obtain a vector of length N. For K number of agent entities, let Pₖ={P_{1,k}, . . . , P_{N,k}} be the vector of importance scores of the local model parameter vector computed by agent entity k. Then, each component can be transmitted using direct analog modulation, that is, the k:th agent entity transmits the N components of the vector of importance scores directly over N resource elements (REs). Here an RE could be, for example: (i) one sample in time in a single-carrier system, or (ii) one subcarrier in one OFDM symbol in a multicarrier system, or (iii) a particular spatial beam or a combination of a beam and a time/frequency resource. In this case, the superposition nature of the wireless channel can be exploited to compute the aggregated importance scores, P₁+P₂+ . . . +P_{K}. More specifically, rather than sending {P₁, . . . , P_{K}} to the server entity 200 on separate channels, the agent entities 300a:300K send {P₁, . . . , P_{K}} simultaneously, using N REs, through linear analog modulation. The server entity 200 exploits the wave superposition property of the wireless channel; {P₁, . . . , P_{K}} add up in the air. Neglecting noise and interference, the server entity 200 thus receives the linear sum, P₁+P₂+ . . . +P_{K}, as desired.

In another example, the agent entities 300a:300K receive a resource budget that can be distributed among the components of the local model parameter vector when computing the importance scores. For instance, one agent entity 300a may assign the whole resource budget on one individual component of its local model parameter vector whilst another agent entity 300b may distribute the resource budget equally among all components of its local model parameter vector. This can be helpful when combined with the over-the-air computation as it harmonizes the importance scores between different agent entities 300a:300K.

In another example, each agent entity 300a:300K ranks the model parameters according to their determined importance score and transmits the ranking, or a subset of the ranking (for example, a pre-determined number of top-ranked most important components) to the server entity 200. The server entity 200 then aggregates the rankings using any rank aggregation method, such as Borda count, instant runoff or Schultze. In this way the server entity 200 obtains a global importance ranking based on which the server entity 200 can decide in each iteration round which components of the global parameter vector to broadcast.

The agent entities 300a:300K might thus support the server entity 200 for the importance score to be determined jointly by sending a status report to the server entity 200. Therefore, in some embodiments, the server entity 200 is configured to perform (optional) step S108.

S108: The server entity 200 obtains the information of the importance score by receiving status reports from the agent entities 300a:300K.

In some non-limiting examples, the status report from a given agent entity 300k indicates any, or any combination, of: a ranking value per each component of the local model parameter vector, where the ranking values are determined by the given agent entity 300k, which of the components of the global parameter vector were recently received by the given agent entity 300k, which of the components of the global parameter vector the given agent entity 300k has been able to correctly decode. In some embodiments, the importance score is determined as an aggregate based on status reports received from at least two of the agent entities 300a:300K.

One advantage of involving the agent entities 300a:300K in the determination of the importance score is the potential inclusion of information related to the private data only residing in each of the agent entities 300a:300K.

Aspects where the importance score is determined at the agent entity side will be disclosed next.

As will be further disclosed, one or more of the agent entities 300a:300K might themselves determine the importance score, for example using similar techniques as outlined above where the importance score is determined at the server entity side and/or where the importance score is determined jointly at the server entity side and at the agent entity side.

The agent entities 300a:300K might then either explicitly or implicitly inform the server entity 200 of the importance score so that the server entity 200 in step S106 is able to obtain information of the importance score given per each component of the global parameter vector and/or of the local model parameter vector. One way for the the agent entities 300a:300K to implicitly inform the inform the server entity 200 of the importance score is for the agent entities 300a:300K to adapt transmission per each component of the local model parameter vector in one of more of the manners disclosed below, and where the server entity 200 then performs blind decoding to implicitly obtain the information of the importance score. In particular, in some embodiments, the importance score is given per each component of the local model parameter vector, and the server entity 200 obtains the information of the importance score by testing different schemes for receiving and/or decoding the local model parameter vectors. Another way for the the agent entities 300a:300K to at least implicitly inform the inform the server entity 200 of the importance score is for the agent entities 300a:300K to send a status report (as received by the server entity 200 in step S106).

The transmission per each component of the global parameter vector and/or of the local model parameter vector might further be adapted based for example on available radio resources, battery levels, radio link quality, expected interference from neighboring cells, or on observed model convergence.

Aspects of how the server entity 200 could adapt transmission per each component of the global parameter vector as in step S110a and/or reception per each component of the local model parameter vector as in S110b will be disclosed next.

The components of the global parameter vector and/or of the local model parameter vectors might be grouped based on their importance scores. For example, the components can be grouped into either high, medium or low importance depending on their importance scores. The server entity 200 can then adapts it transmission of the global parameter vector and/or its reception of the local model parameter vectors accordingly for each group depending on their importance. In particular, in some embodiments, each of the components might be classified as having either a high importance score or a low importance score, or an intermediate importance score between the low importance score and the high importance score. However, for illustrative purposes, and without loss of generality, it will be assumed that components of the global parameter vector and/or of the local model parameter vector are portioned into two importance levels. This corresponds to the importance score for each component taking a binary value; high importance or low importance. The extension to scenarios with more than two levels of importance scores is straightforward. Let vector vₐ be a vector (representing either the global parameter vector or the local model parameter vector) containing the components with a high importance score (thus representing high importance components), and let vector v_{b} be a vector (representing either the global parameter vector or the local model parameter vector) containing the components with a low importance score (thus representing low importance components).

In one example, the downlink transmission and/or the uplink transmission is adapted by more redundancy being applied to the components with high importance score. Then, for example, vector vₐ could be transmitted with a first level of redundancy and vector v_{b} could be transmitted with a second level of redundancy, where the first level of redundancy is higher than the second level of redundancy. Here, one example of adding redundancy is by means of running an encoding algorithm where more error protection (such as by block codes or convolutional codes) is added. Hence, in some embodiments, adapting the transmission comprises adapting a level of redundancy as applied to the components of the global parameter vector and/or of the local model parameter vector associated in accordance with the importance score. A higher level of redundancy is applied to the components having the high importance score than to the components having the low importance score. The reception is adapted accordingly, where thus a higher level of redundancy is removed, by running the appropriate decoding algorithm, from the components having the high importance score than from the components having the low importance score. How much redundancy to be removed at the receiver side generally depends on how much redundancy was added at the transmitter side.

In some aspects, the error protection scheme used by the server entity 200 (and/or by the agent entities 300a:300K) is updated.

In one example, the downlink transmission and/or the uplink transmission is adapted by more error protection being applied to the components with high importance score. Then, for example, vector vₐ could be transmitted with a first MCS and vector v_{b} could be transmitted with a second MCS, where the first MCS has lower probability of error than the second MCS. When selecting an MCS for vector vₐ, extra parity bits, or an additional error check (e.g. a cyclic redundancy check (CRC)) could be added in comparison to vector v_{b} to increase the probability that vector vₐ is received correctly. Hence, in some embodiments, adapting the transmission comprises adapting an MCS as applied to the components of the global parameter vector and/or of the local model parameter vector associated in accordance with the importance score. A more robust MCS is applied to the components having the high importance score than to the components having the low importance score.

In some aspects, the modulation format used by the server entity 200 (and/or by the agent entities 300a:300K) is updated. The reception is adapted accordingly, where the components are decoded using the same MCSs as applied during transmission.

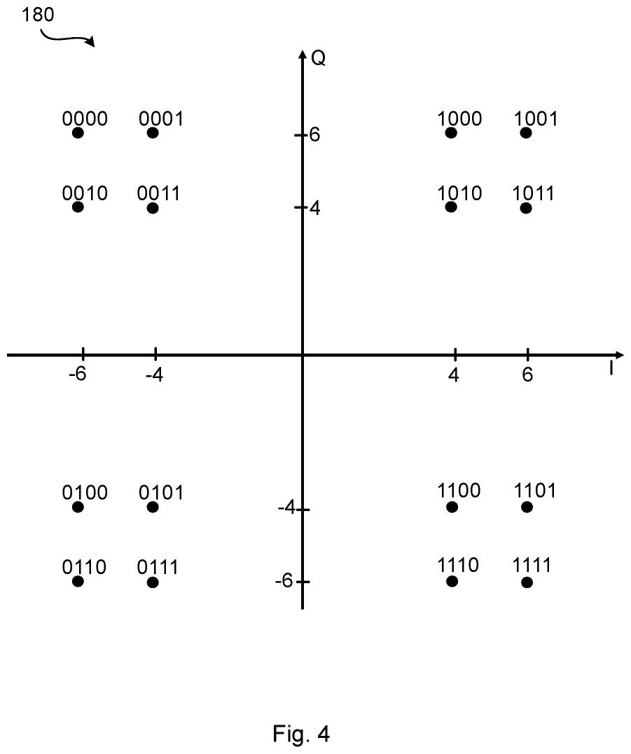

In some examples, a nonuniform signal constellation is used. Bits from one component of vector vₐ and bits from one component of vector v_{b} could be used to determine a point from a nonuniform constellation. In this example, the first two bits are selected from vector vₐ and the last two bits are selected from vector v_{b}. When the signal to noise ratio (SNR) of the radio propagation channel 150 is good, there is a high probability that all four bits can be decoded (and hence both vectors vₐ and v_{b} can be recovered) but if the SNR is poor, there is a high probability that only the first two bits (from vector vₐ) can be decoded. An example of this is illustrated in FIG. 4. In FIG. 4 is illustrated a nonuniform signal constellation 180, where in each quadrant of the inphase and quadrature diagram the different vectors are grouped, and where the two first (and most significant) bits are the same within each group. The reception is adapted accordingly, where the components are decoded using the same nonuniform signal constellation as used during transmission.

In some aspects, the hybrid automatic repeat request (HARQ) process used by the server entity 200 (and/or by the agent entities 300a:300K) is updated.

In some examples, all components of vector vₐ are sent before any components of vector v_{b} are sent. If decoding at the receiver side of vector vₐ fails, then more parity bits are requested using incremental redundancy (IR) HARQ by the receiver sending a negative acknowledgement (NACK) to the transmitter). Vector v_{b} can then be sent if decoding succeeds (so that there are spare resources available). Hence, in some embodiments, adapting the transmission comprises adapting a HARQ scheme as applied to the components of the global parameter vector and/or of the local model parameter vector associated in accordance with the importance score.

Transmission of the components having the low importance score is delayed until transmission of the components having the high importance score has succeeded.

In some aspects, the quantization scheme used by the server entity 200 (and/or by the agent entities 300a:300K) is updated.

In some examples, the downlink transmission and/or the uplink transmission is further adapted by finer quantization being applied to vector vₐ than to vector v_{b}. For example, for each component of vector v_{b}, only the sign may be retained. For each component of vector vₐ, the sign and some magnitude information may be kept. Vector quantization can also be used to encode pairs of parameters that have been deemed to be correlated. Hence, in some embodiments, adapting the transmission comprises adapting a quantization scheme as applied to the components of the global parameter vector and/or of the local model parameter vector associated in accordance with the importance score. A finer resolution quantization scheme is applied to the components having the high importance score than to the components having the low importance score. The reception is adapted accordingly, where a reproducer set with finer granularity is used for the components having been quantized with the finer resolution quantization scheme.

One way to reduce the size of the global parameter vector and/or of the local model parameter vector by sparsification. Hence, in some embodiments, adapting the transmission comprises adapting a sparsification scheme as applied to the components of the global parameter vector and/or of the local model parameter vector associated in accordance with the importance score. A higher level of sparsification is applied to the components having the low importance score than to the components having the high importance score. The reception is adapted accordingly, where a desparsification scheme with a higher level of desparsification is applied to the components having the low importance score than to the components having the high importance score.

If a neural network is used, sparsification can be achieved by reducing the neural network size by setting the values of components with low magnitude to zero, without substantial loss of accuracy. The sparsification method indicates how small magnitude weights are of less important than higher weights. This information can be used to set the importance score by first aggregating the model parameters (weights) into a cumulative distribution, and then associate certain percentiles with a certain importance score. The importance score can be estimated by the agent entities 300a:300K first reporting the distribution of weights after local training, or certain percentiles. In subsequent step, the weights associated with high magnitude values can be configured with a high importance score, and less magnitude associated with a low importance score.

In some aspects, only the components that have an importance score above a certain threshold are transmitted. This threshold can in turn be either pre-determined, or adapted depending on the amount of resources available in the network or as function of how critical it is that the machine learning model converges quickly. An application that has experienced slow convergence may lower the threshold so that more components are transmitted, which should improve convergence speed. In particular, in some embodiments, only a subset of all the components of the global parameter vector and/or the local model parameter vector is transmitted per each iteration round, and adapting transmission comprises including in the subset only the components for which the importance score is higher than a threshold value. In some non-limiting examples, the threshold value is determined according to any, or any combination, of: a predetermined value, a function of available network resources for transmission of the global parameter vector and/or the local model parameter vectors, a convergence criterion for the machine learning model.

In case a component of a received local model parameter vector cannot be decoded, the server entity 200 can use the latest retrieved model parameters, or configure the model parameter to be zero, or close to zero. The server entity 200 can further use statistics on previous successful reception of certain model parameters to decide the importance score for each parameter in subsequent iteration rounds. For example, the server entity 200 can increase the importance score for a component that has not been received in a number of iterations. Hence, in some embodiments, less than all the components of the global parameter vector are transmitted in each iteration round, and the importance score for the given component increases with how many iteration rounds since said given component was transmitted. In other words, if one component of the global parameter vector was not transmitted in the most recent iteration round, or even a number of consecutive earlier iteration rounds, the importance score of that component may be increased in accordance with any suitable methodology. According to one non-limiting illustrative example, the importance score may be increased with 10% for every missed iteration round.

Re-computation of model parameter importance may be triggered, for example, periodically (at the expiry of a timer set to a pre-determined value) or adaptively, for example, if model convergence problems have been detected, or if the availability of radio resources has changed significantly. For instance, if suddenly the network traffic increases drastically so that the system is starved of resources, then the server entity 200 might decide to broadcast the components of the global parameter vector more selectively and invoke the importance score computation, based on which the server entity 200 decides which components of the global parameter vector to broadcast. Conversely, if the system goes from high-traffic to low-traffic load, with a lot of empty resources, then the server entity might decide to perform a full broadcast of the global parameter vector, thereby no longer necessitating the use or calculation of the importance score per component.

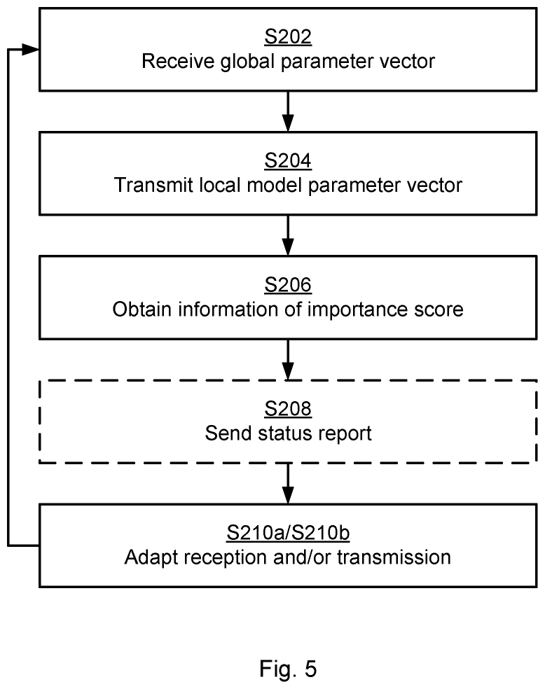

Reference is now made to FIG. 5 illustrating a method for performing an iterative learning process with a server entity 200 as performed by the agent entity 300k according to an embodiment.

The iterative learning process pertains to a computational task to be performed by the agent entity 300k. The computational task pertains to the agent entity 300k participating in training a machine learning model. For each iteration round of the iterative learning process the server entity 200 sends a global parameter vector of the computational task to the agent entity 300k. For each iteration round of the iterative learning process the agent entity 300k sends a local model parameter vector with locally computed computational results to the server entity 200, wherein the locally computed computational results are updates of the machine learning model.

S202: The agent entity 300k receives the global parameter vector of a current iteration round of the iterative learning process from the server entity 200.

S204: The agent entity 300k transmits a local model parameter vector of the current iteration round of the iterative learning process to the agent entity 300k.

S206: The agent entity 300k obtains information of an importance score given per each component of the global parameter vector and/or of the local model parameter vector.

Then, at least one of steps S210a and S210b is performed. That is, either step S210a is performed but step S210b is not performed, or step S210b is performed but step S210a is not performed, or boths step S210a and S210b are performed.

S210a: The agent entity 300k adapts reception per each component of the global parameter vector for the next iteration round of the iterative learning process based on the importance score per parameter when the importance score is given per parameter of the global parameter vector.

S210b: The agent entity 300k adapts transmission per each component of the local model parameter vector for a next iteration round of the iterative learning process based on the importance score per parameter when the importance score is given per parameter of the local model parameter vector.

Embodiments relating to further details of performing an iterative learning process with a server entity 200 as performed by the agent entity 300k will now be disclosed.

As disclosed above, in some embodiments, the importance score per given component pertains to a priority score for the given component for contributing to the training of the machine learning model.

As disclosed above, in some embodiments, the components represent weights at different layers in a neural network, and the weights have same value per each layer of the neural network.

Aspects where the importance score is determined jointly at the server entity side and at the agent entity side will be disclosed next.

As disclosed above, the agent entity 300k might support the server entity 200 for the importance score to be determined jointly by sending a status report to the server entity 200. Therefore, in some embodiments, the agent entity 300k is configured to perform (optional) step S208.

S208: The agent entity 300k sends a status report to the agent entity 300k.

In some non-limiting examples, the status report indicates any, or any combination of: a ranking value per each component of the local model parameter vector, where the ranking values are determined by the agent entity 300k, which of the components of the global parameter vector were recently received by the agent entity 300k, which of the components of the global parameter vector the agent entity 300k has been able to correctly decode.

Aspects where the importance score is determined at the agent entity side will be disclosed next.

As disclosed above, the agent entity 300k might itself determine the importance score, for example using similar techniques as outlined above where the importance score is determined at the server entity side and/or where the importance score is determined jointly at the server entity side and at the agent entity side.

Further, in some aspects, the importance score depends on the accuracy per component. In particular, in some embodiments, the agent entity 300k obtains the information of the importance score by estimating accuracy per each component of the global parameter vectors as received from the server entity 200.

Further, in some aspects, the importance score is based on the magnitude of the model parameters. In particular, in some embodiments, each of the components has a respective magnitude, and the importance score for a given component is a function of the magnitude for the given component, and/or a function of the magnitude of the given component for a present iteration compared to a reference. The reference is the magnitude of the given component computed for a previous iteration, and the importance score increases with the magnitude.

Further, in some aspects, the importance score is based on fluctuations of the radio propagation channel 150. Hence, in some embodiments, the importance score pertains to properties of the radio propagation channel 150 between the server entity 200 and the agent entities 300a:300K. For example, if the radio propagation channel 150 from the client entity 300k towards the server entity 200 is deemed to be stable, the channel capacity is rather predictable and the agent entity 300k may send components with high importance scores and components with low importance scores together, encoded in one block. By way of contrast, if the radio propagation channel 150 is deemed to be unstable the agent entity 300k may instead first send only the components with high importance scores (possibly with extra error protection) to ensure that these components reach the server entity 200 before the components with low importance score are sent, as in the above disclosed HARQ procedure.

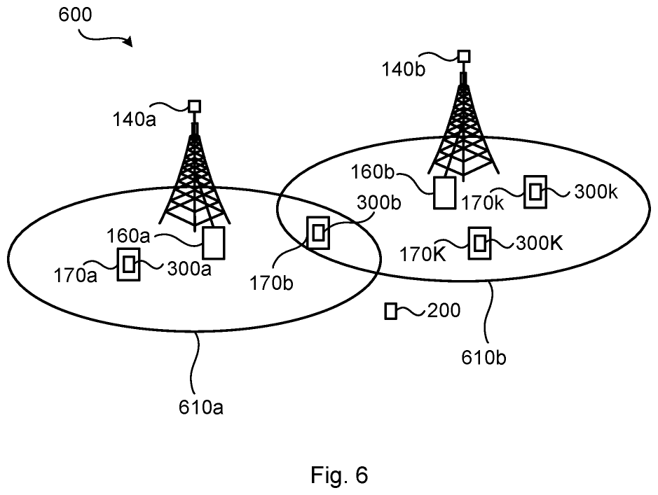

The herein disclosed embodiments are applicable in communication network supporting Multimedia Broadcast multicast service Single Frequency Network (MBSFN) operation. In FIG. 6 is illustrated an example of a communication network 600 where there are two network nodes 140a, 140b, each serving a respective cell 610a, 610b, where the cells 610a, 610b collectively define the coverage region of the (radio) access network 110. For illustrative purposes, cell 610a serves a first MBSFN area and cell 610b serves a second MBSFN area. User equipment located in an overlap between the cells 610a, 610b might belong to either the first MBSFN area or the second MBSFN area, depending on whether the user equipment is served by the network node 140a or network node 140b. However, in general terms, the server entity 200 can base the MBSFN areas on which parameter vector the agent entities 300a:300K lastly have received. If a majority of agent entities 300a:300K in the user equipment served in a given cell have not received the lastly sent parameter vector, it can be advantageous to perform a MBSFN transmission where the transmission (and corresponding reception) of the global parameter vector and/or local model parameter vectors is/are adapted as herein disclosed, since this can improve the signal to interference ratio (SIR) of the reception. This can enable more agent entities to participate in the iterative learning process.

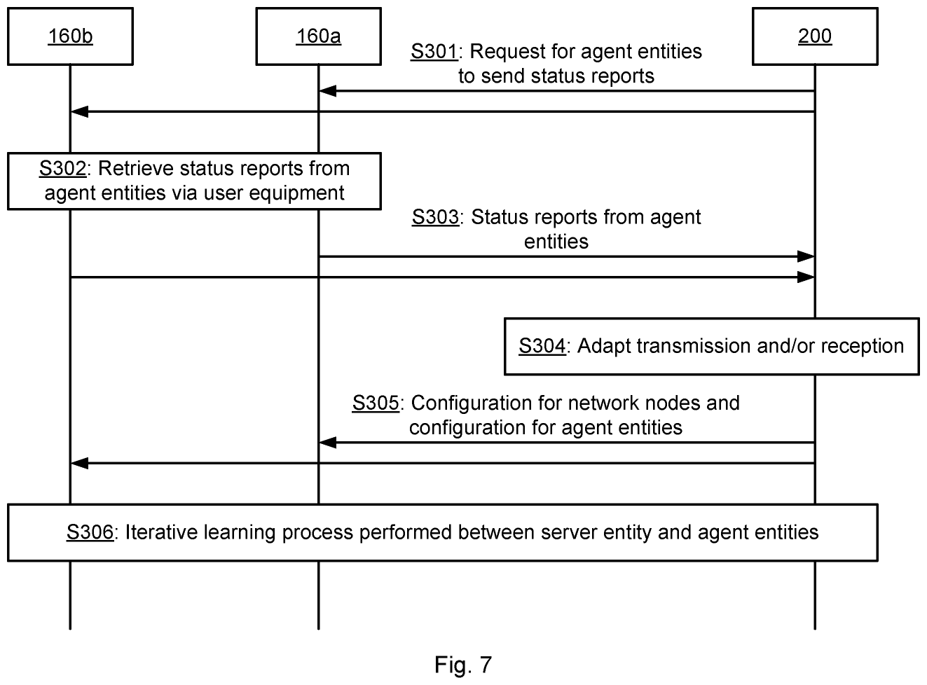

Reference is next made to the signalling diagram of FIG. 7 which illustrates an embodiment of performing an iterative learning process between a server entity 200 and agent entities provided in user equipment 160a, 160b. The importance score given per each component of the global parameter vector and/or of the local model parameter vector is here determined by the server entity 200 based on status reports received from the agent entities via the user equipment 160a, 160b.

S301: The server entity 200, via the user equipment 160a, 160b, requests the agent entities to send status reports to the server entity 200.

S302: The user equipment 160a, 160b restive the status reports from the agent entities accordingly.

S303: The user equipment 160a, 160b send the thus retrieved status reports towards the server entity 200.

S304: The server entity 200, based on the received status reports, determines an importance score given per each component of the global parameter vector and/or of the local model parameter vector. The server entity 200 adapts transmission per each component of the global parameter vector for a next iteration round of the iterative learning process and/or reception per each component of the local model parameter vector for the next iteration round of the iterative learning process based on the importance score per parameter S305: The server entity 200 provides configuration to the user equipment 160a, 160b and the agent entities so that the user equipment 160a, 160b and the agent entities can adapt their reception and/or transmission accordingly.

S306: The next iteration round of the iterative learning process is performed between the server entity 200 and the agent entities via the user equipment 160a, 160b.

Non-limiting examples of scenarios where the herein disclosed embodiments can be applied will be disclosed next.

According to a first example, the computational task pertains to prediction of best secondary carrier frequencies to be used by user equipment 170a:170K in which the agent entities 300a:300K are provided. The data locally obtained by the agent entity 300k can then represent a measurement on a serving carrier of the user equipment 170k. In this respect, the best secondary carrier frequencies for user equipment 170a:170K can be predicted based on their measurement reports on the serving carrier. The secondary carrier frequencies as reported thus defines the computational result. In order to enable such techniques, the agent entities 300a:300K can be trained by the server entity 200, where each agent entity 300k, according to the machine learning model, takes as input the measurement reports on the serving carrier(s) (among possibly other available reports such as timing advance, etc.) and as outputs a prediction of whether the user equipment 170k in which the agent entity 300k is provided has coverage or not in the secondary carrier frequency.

According to a second example, the computational task pertains to compressing channel-state-information using an auto-encoder, where the server entity 200 implements a decoder of the auto-encoder, and where each of the agent entities 300a:300K, according to the machine learning model, implements a respective encoder of the auto-encoder. An autoencoder can be regarded as a type of neural network used to learn efficient data representations.

According to a third example, the computational task pertains to signal quality drop prediction. The signal quality drop prediction is based on measurements on wireless links used by user equipment 170a:170K in which the agent entities 300a:300K are provided. In this respect, based on received data, in terms of computational results, in the reports, the server entity 200 can learn, for example, what sequence of signal quality measurements (e.g., reference signal received power; RSRP) that results in a large signal quality drop. After a machine learning model is trained, for instance using the iterative learning process, the server entity 200 can provide the model to the agent entities 300a:300K. The model can be provided either to agent entities 300a:300K having taken part in the training, or to other agent entities 300a:300K. The agent entities 300a:300K can then apply the model to predict future signal quality values. This signal quality prediction can then be used in the context of any of: initiating inter-frequency handover, setting handover and/or reselection parameters, changing device scheduler priority so as to schedule the user equipment 170a:170K when the expected signal quality is good. The data for training such a model is located at the device-side where the agent entities 300a:300K reside, and hence an iterative learning process as disclosed herein can be used to efficiently learn the future signal quality prediction.

According to a fourth example, the iterative learning procedure concerns mapping one or more geolocations to a radio signal quality values, or bitrate values. This can be used by the network to create an understanding of potential network coverage holes in a cell, and how the bitrate varies within the cell. However, a device-reported geolocation can violate privacy concerns of the user equipment, and therefore an iterative learning procedure can be used since it only comprises signaling of parameter vectors. As an illustrative example assume that agent entities 300a:300K have a dataset of geolocation to Signal-to-Interference-plus-Noise Ratio (SINR) mappings according to each respective dotted area (where the SINR takes a normalized value from 0 to 1). The agent entities 300a:300K then perform an iterative learning procedure with the server entity 200 in order to include their dataset information in a global machine learning model to be used by the network.

According to a fifth example, the iterative learning procedure concerns surveillance, using a network of cameras, of a particular area public or private). Each camera is associated with its own agent entity 300a:300K. The network is configured to learn a global machine learning model that can be used to detect whether suspicious activity is ongoing in any of the video imagery as captured by the cameras. The suspicious activity could pertain to identifying unauthorized persons present in a private area, identifying vehicles in the area, or monitoring the area for any criminal activity. The cameras however, for privacy reasons, are not allowed to share their raw image data. An iterative learning procedure can then be used to train the global machine learning model, where the cameras share only model (gradient) updates in terms of parameter vectors, rather than their observations. In this case the parameter vectors might represent predictions of the content in the images (for examples, parameters of a face recognition algorithm).

According to a sixth example, the iterative learning procedure concerns a natural language processing application. The agent entities 300a:300K could learn a language model that represents a machine learning model, for example for text prediction when typing on a user equipment 170a:170K, such as a mobile device, where each of the agent entities 300a:300K thus could be associated with their own user equipment 170a:170K. Using an iterative learning procedure, only updates to the model need to be shared, but raw text data will not be shared.

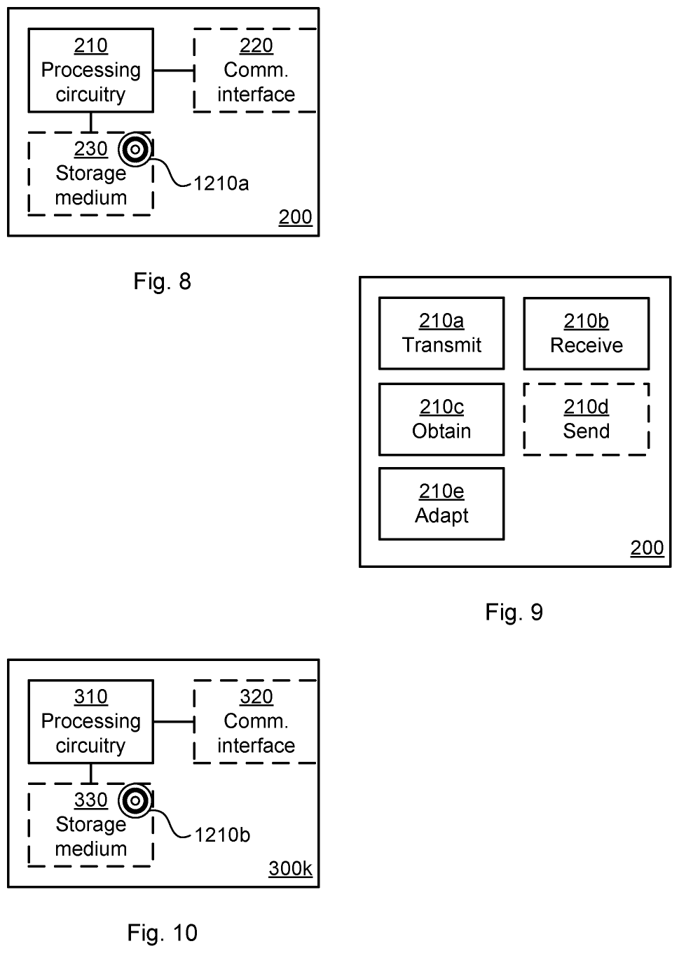

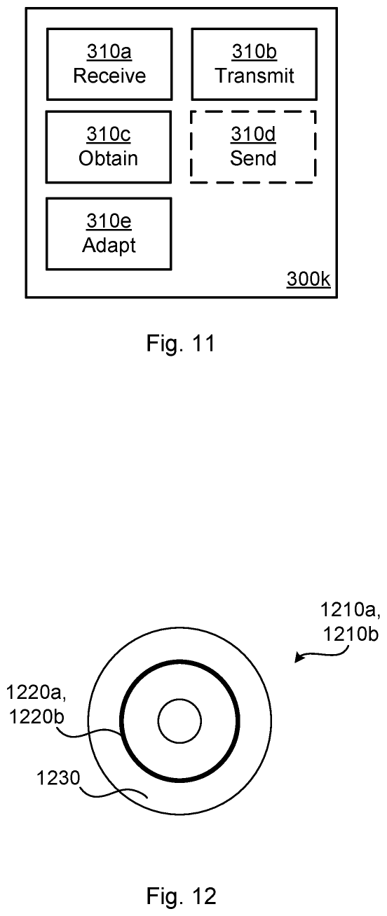

FIG. 8 schematically illustrates, in terms of a number of functional units, the components of a server entity 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1210a (as in FIG. 12), e.g. in the form of a storage medium 230. The processing circuitry 210 may further be provided as at least one application specific integrated circuit (ASIC), or field programmable gate array (FPGA).

Particularly, the processing circuitry 210 is configured to cause the server entity 200 to perform a set of operations, or steps, as disclosed above. For example, the storage medium 230 may store the set of operations, and the processing circuitry 210 may be configured to retrieve the set of operations from the storage medium 230 to cause the server entity 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server entity 200 may further comprise a communications interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server entity 200 e.g. by sending data and control signals to the communications interface 220 and the storage medium 230, by receiving data and reports from the communications interface 220, and by retrieving data and instructions from the storage medium 230. Other components, as well as the related functionality, of the server entity 200 are omitted in order not to obscure the concepts presented herein.

FIG. 9 schematically illustrates, in terms of a number of functional modules, the components of a server entity 200 according to an embodiment. The server entity 200 of FIG. 9 comprises a number of functional modules; a transmit module 210a configured to perform step S102, a receive module 210b configured to perform step S104, an obtain module 210c configured to perform step S106, and an adapt module configured to perform steps S110a, S110b. The server entity 200 of FIG. 9 may further comprise a number of optional functional modules, such as a send module 210d configured to perform optional step S108. In general terms, each functional module 210a:210e may be implemented in hardware or in software. Preferably, one or more or all functional modules 210a:210e may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210e and to execute these instructions, thereby performing any steps of the server entity 200 as disclosed herein.

The server entity 200 may be provided as a standalone device or as a part of at least one further device. For example, the server entity 200 may be provided in a node of the radio access network or in a node of the core network. Alternatively, functionality of the server entity 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the server entity 200 may be executed in a first device, and a second portion of the instructions performed by the server entity 200 may be executed in a second device; the herein disclosed embodiments are not limited to any particular number of devices on which the instructions performed by the server entity 200 may be executed. Hence, the methods according to the herein disclosed embodiments are suitable to be performed by a server entity 200 residing in a cloud computational environment. Therefore, although a single processing circuitry 210 is illustrated in FIG. 8 the processing circuitry 210 may be distributed among a plurality of devices, or nodes. The same applies to the functional modules 210a:210e of FIG. 9 and the computer program 1220a of FIG. 12.

FIG. 10 schematically illustrates, in terms of a number of functional units, the components of an agent entity 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1210b (as in FIG. 12), e.g. in the form of a storage medium 330. The processing circuitry 310 may further be provided as at least one application specific integrated circuit (ASIC), or field programmable gate array (FPGA).

Particularly, the processing circuitry 310 is configured to cause the agent entity 300k to perform a set of operations, or steps, as disclosed above. For example, the storage medium 330 may store the set of operations, and the processing circuitry 310 may be configured to retrieve the set of operations from the storage medium 330 to cause the agent entity 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The agent entity 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the agent entity 300k e.g. by sending data and control signals to the communications interface 320 and the storage medium 330, by receiving data and reports from the communications interface 320, and by retrieving data and instructions from the storage medium 330. Other components, as well as the related functionality, of the agent entity 300k are omitted in order not to obscure the concepts presented herein.

FIG. 11 schematically illustrates, in terms of a number of functional modules, the components of an agent entity 300k according to an embodiment. The agent entity 300k of FIG. 11 comprises a number of functional modules; a receive module 310a configured to perform step S202, a transmit module 310b configured to perform step S204, an obtain module 310c configured to perform step S206, and an adapt module 310e configured to perform steps S210a, S210b. The agent entity 300k of FIG. 11 may further comprise a number of optional functional modules, such as a send module 310d configured to perform optional step S208. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the agent entity 300k as disclosed herein.

FIG. 12 shows one example of a computer program product 1210a, 1210b comprising computer readable means 1230. On this computer readable means 1230, a computer program 1220a can be stored, which computer program 1220a can cause the processing circuitry 210 and thereto operatively coupled entities and devices, such as the communications interface 220 and the storage medium 230, to execute methods according to embodiments described herein. The computer program 1220a and/or computer program product 1210a may thus provide means for performing any steps of the server entity 200 as herein disclosed. On this computer readable means 1230, a computer program 1220b can be stored, which computer program 1220b can cause the processing circuitry 310 and thereto operatively coupled entities and devices, such as the communications interface 320 and the storage medium 330, to execute methods according to embodiments described herein. The computer program 1220b and/or computer program product 1210b may thus provide means for performing any steps of the agent entity 300k as herein disclosed.

In the example of FIG. 12, the computer program product 1210a, 1210b is illustrated as an optical disc, such as a CD (compact disc) or a DVD (digital versatile disc) or a Blu-Ray disc. The computer program product 1210a, 1210b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1220a, 1220b is here schematically shown as a track on the depicted optical disk, the computer program 1220a, 1220b can be stored in any way which is suitable for the computer program product 1210a, 1210b.

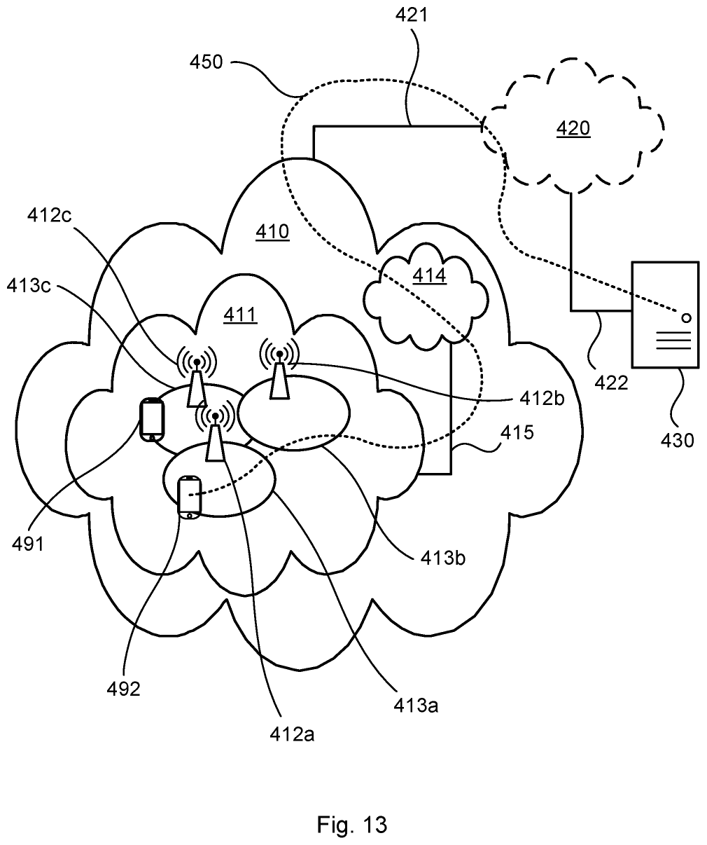

FIG. 13 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the UEs 170a:170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

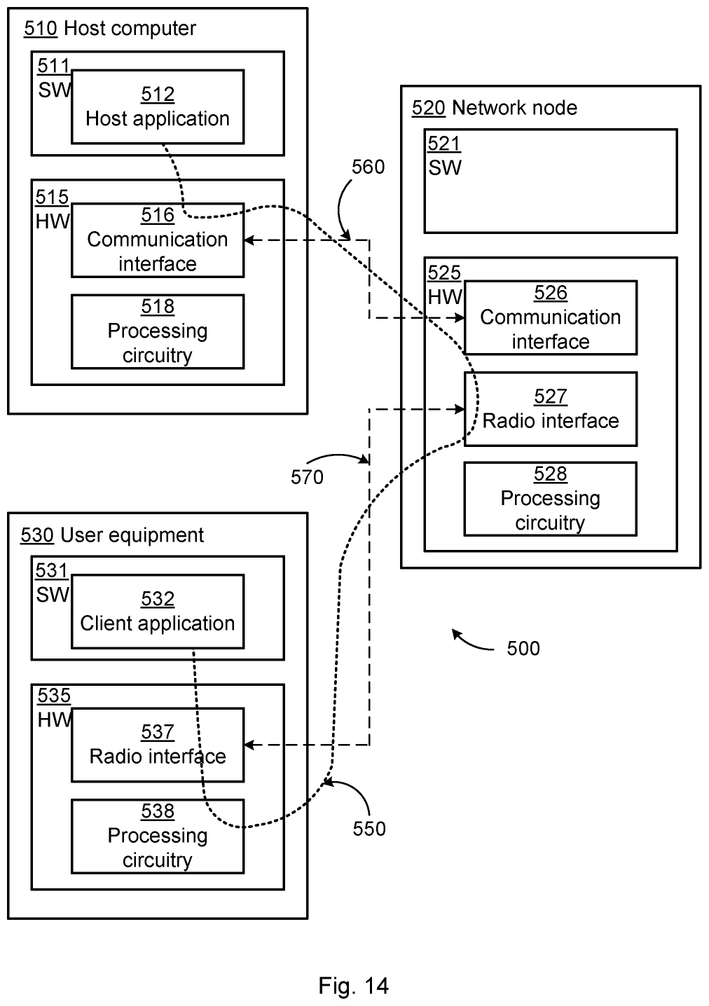

FIG. 14 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the UEs 170a:170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by radio access network node 520. Communication interface 526 may be configured to facilitate connection 560 to host computer 510. Connection 560 may be direct or it may pass through a core network (not shown in FIG. 14) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 14 may be similar or identical to host computer 430, one of network nodes 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing an iterative learning process with agent entities, wherein the method is performed by a server entity,
wherein the iterative learning process pertains to a computational task to be performed by the agent entities, the computational task pertaining to the agent entities participating in training a machine learning model,
wherein for each iteration round of the iterative learning process the server entity sends a global parameter vector of the computational task to the agent entities,
wherein for each iteration round of the iterative learning process a local model parameter vector with locally computed computational results is sent per agent entity to the server entity, wherein the locally computed computational results are updates of the machine learning model, and
wherein the method comprises:
transmitting the global parameter vector of a current iteration round of the iterative learning process to the agent entities;
receiving a respective local model parameter vector of the current iteration round of the iterative learning process from the agent entities;
obtaining information of an importance score given per each component of the global parameter vector and/or of the local model parameter vector; and
adapting transmission per each component of the global parameter vector for a next iteration round of the iterative learning process based on the importance score per parameter when the importance score is given per parameter of the global parameter vector, and/or adapting reception per each component of the local model parameter vector for the next iteration round of the iterative learning process based on the importance score per parameter when the importance score is given per parameter of the local model parameter vector.

2. The method according to claim 1, wherein the method further comprises:
sending information of how the transmission and/or reception was adapted before the next iteration round.

3. The method according to claim 1, wherein the importance score per given component pertains to a priority score for the given component for contributing to the training of the machine learning model.

4. The method according to claim 1, wherein the server entity obtains the information of the importance score by estimating accuracy per each component of the local model parameter vectors as received from the agent entities.

5. The method according to claim 1, wherein each of the components has a respective magnitude, wherein the importance score for a given component is a function of the magnitude for said given component, and/or a function of the magnitude of said given component for a present iteration round compared to a reference, wherein the reference is the magnitude of said given component computed for a previous iteration round, and wherein the importance score increases with the magnitude.

6. The method according to claim 1, wherein the components represent weights at different layers in a neural network, and wherein the weights have same importance score per each layer of the neural network.

7. The method according to claim 1, wherein the importance score pertains to properties of a radio propagation channel between the server entity and the agent entities.

8. The method according to claim 1, wherein less than all the components of the global parameter vector are transmitted in each iteration round, and wherein the importance score for said given component increases with how many iteration rounds since said given component was transmitted.

9. The method according to claim 1, wherein the server entity obtains the information of the importance score by receiving status reports from the agent entities, wherein the status report from a given agent entity (300k) indicates any of:
a ranking value per each component of the local model parameter vector, wherein the ranking values are determined by said given agent entity,
which of the components of the global parameter vector were recently received by said given agent entity,
which of the components of the global parameter vector said given agent entity has been able to correctly decode.

10. The method according to claim 9, wherein the importance score is determined as an aggregate based on status reports received from at least two of the agent entities.

11. The method according to claim 1, wherein the importance score is given per each component of the local model parameter vector, and wherein the server entity obtains the information of the importance score by testing different schemes for receiving and/or decoding the local model parameter vectors.

12. The method according to claim 1, wherein each of the components is classified as having either a high importance score or a low importance score, or an intermediate importance score between the low importance score and the high importance score.

13. The method according to claim 1, wherein adapting transmission comprises adapting a level of redundancy as applied to the components of the global parameter vector and/or of the local model parameter vector associated in accordance with the importance score, and wherein a higher level of redundancy is applied to the components having the high importance score than to the components having the low importance score.

14. The method according to claim 1, wherein adapting transmission comprises adapting a modulation and coding scheme as applied to the components of the global parameter vector and/or of the local model parameter vector associated in accordance with the importance score, and wherein a more robust modulation and coding scheme is applied to the components having the high importance score than to the components having the low importance score.

15. The method according to claim 1, wherein adapting transmission comprises adapting a HARQ scheme as applied to the components of the global parameter vector and/or of the local model parameter vector associated in accordance with the importance score, and wherein transmission of the components having the low importance score is delayed until transmission of the components having the high importance score has succeeded.

16. The method according to claim 1, wherein only a subset of all the components of the global parameter vector and/or the local model parameter vector is transmitted per each iteration round, and wherein adapting transmission comprises including in the subset only the components for which the importance score is higher than a threshold value.

17. (canceled)

18. The method according to claim 1, wherein adapting transmission comprises adapting a quantization scheme as applied to the components of the global parameter vector and/or of the local model parameter vector associated in accordance with the importance score, and wherein a finer resolution quantization scheme is applied to the components having the high importance score than to the components having the low importance score.

19. The method according to claim 1, wherein adapting transmission comprises adapting a sparsification scheme as applied to the components of the global parameter vector and/or of the local model parameter vector associated in accordance with the importance score, and wherein a higher level of sparsification is applied to the components having the low importance score than to the components having the high importance score.

20. A method for performing an iterative learning process with a server entity, wherein the method is performed by an agent entity,
wherein the iterative learning process pertains to a computational task to be performed by the agent entity, the computational task pertaining to the agent entity participating in training a machine learning model,
wherein for each iteration round of the iterative learning process the server entity sends a global parameter vector of the computational task to the agent entity,
wherein for each iteration round of the iterative learning process the agent entity sends a local model parameter vector with locally computed computational results to the server entity, wherein the locally computed computational results are updates of the machine learning model, and
wherein the method comprises:
receiving the global parameter vector of a current iteration round of the iterative learning process from the server entity;
transmitting a local model parameter vector of the current iteration round of the iterative learning process to the agent entity;
obtaining information of an importance score given per each component of the global parameter vector and/or of the local model parameter vector; and
adapting reception per each component of the global parameter vector for the next iteration round of the iterative learning process based on the importance score per parameter when the importance score is given per parameter of the global parameter vector, and/or adapting transmission per each component of the local model parameter vector for a next iteration round of the iterative learning process based on the importance score per parameter when the importance score is given per parameter of the local model parameter vector.

21-27. (canceled)

28. A server entity for performing an iterative learning process with agent entities,
wherein the iterative learning process pertains to a computational task to be performed by the agent entities, the computational task pertaining to the agent entities participating in training a machine learning model,
wherein for each iteration round of the iterative learning process the server entity sends a global parameter vector of the computational task to the agent entities,
wherein for each iteration round of the iterative learning process a local model parameter vector with locally computed computational results is sent per agent entity to the server entity, wherein the locally computed computational results are updates of the machine learning model,
the server entity comprising processing circuitry, the processing circuitry being configured to cause the server entity to:
transmit the global parameter vector of a current iteration round of the iterative learning process to the agent entities;
receive a respective local model parameter vector of the current iteration round of the iterative learning process from the agent entities;
obtain information of an importance score given per each component of the global parameter vector and/or of the local model parameter vector; and
adapt transmission per each component of the global parameter vector for a next iteration round of the iterative learning process based on the importance score per parameter when the importance score is given per parameter of the global parameter vector, and/or adapt reception per each component of the local model parameter vector for the next iteration round of the iterative learning process based on the importance score per parameter when the importance score is given per parameter of the local model parameter vector.

29-36. (canceled)
